(19) United States
(12) Patent Application Publication
(10) Pub. No.: US 2005/0112954 A1
(43) Pub. Date: May 26, 2005

(54) Stabilized electronic apparatus

(75) Inventor: Herve Merlet, Servon-Sur Vilaine (FR)

Correspondence Address: FITZPATRICK CELLA HARPER & SCINTO, 30 ROCKEFELLER PLAZA, NEW YORK, NY, 10112, US

(73) Assignee: CANON EUROPA NV, Amstelveen (NL)

(21) Appl. No.: 10/952,826

(22) Filed: Sep. 30, 2004

(30) Foreign Application Priority Data
Oct. 1, 2003 (FR) 03 11524

(51) Int. Cl. H01R 13/625

(52) U.S. Cl. 439/700

(57) ABSTRACT

An electronic apparatus comprises means of connection to a wall socket, at least one user interface means and at least one interface module between the user interface means and the connection means. This electronic apparatus comprises at least one elastic means in contact with the wall when the connection means is plugged into the wall socket, so as to stabilize the electronic apparatus in a predetermined position relative to the wall and means for disconnecting the connection means from the wall socket, the at least one elastic means cooperating with the disconnecting means to facilitate the disconnection of the electronic apparatus. More particularly, the disclosure is situated in a communications network comprising such electronic apparatuses.

### BACKGROUND OF THE INVENTION

1. Field of the Invention

The present invention relates to an electronic apparatus adapted to being plugged into a wall socket. The electronic apparatuses described in the invention are subjected to mechanical stresses that contribute to destabilizing the device.

The present invention can be applied more particularly to domestic use.

The packages that are plugged into a wall socket may possess numerous connectors into which cables and apparatuses are plugged. These packages are, for example, connector hubs. They may also comprise user interfaces such as programming buttons, switches, etc. Hereinafter, this type of package shall be called an electronic apparatus.

Electronic apparatuses of the connection device type can receive different connections. Their volume is constantly increasing because the number of connections to be made in a dwelling is constantly increasing. These devices are furthermore capable of performing increasing numbers of electronic functions. These electronic apparatuses need to be connected either to an electrical power supply mains in order to be powered, or to a home type of network for example. To this end, most of the electronic apparatuses are adapted to being plugged into a wall socket comprising a female connector adapted to the male connector provided on the electronic apparatus.

When the apparatus is connected to the wall socket, it is important that it should remain in a stable position, on the one hand so that it does not damage the connectors and on the other hand so that it does not get disconnected.

Owing to their great volume, the electronic apparatuses have an equally great weight, especially when they comprise sophisticated electronic boards. Furthermore, these apparatuses often have interfaces that necessitate handling by the user, thus further increasing the mechanical action and stresses that these apparatuses can undergo. Such handling by the user includes, for example the actuating of switches and programming buttons, the connecting or disconnecting of cables, machines etc.

Under the effect of these repeated mechanical actions, the electronic apparatuses get out of balance and are damaged.

Furthermore, when the connector for the wall socket of the electronic apparatus has a clip type clamping means for example, it is sometimes difficult to both unclamp the connector and remove the wall socket device.

2. Description of the Prior Art

There are many connector hubs in the prior art with high connection capacity. These connector hubs are generally connected to the wall socket by means of a connector which is itself connected to the connector hub by means of a cable. This type of system indeed makes it possible to avert the problem of the stabilization of the electronic apparatus since, in this case, it is placed on the ground. However, with this system, this type of connector hub cannot be connected to a wall socket at a height from the ground since a support would then be needed for the hub. Furthermore, it may cause of problem of space in a house or it may be an obstacle in a room.

### SUMMARY OF THE INVENTION

The present invention seeks to resolve the problem of stabilizing an electronic apparatus connected to a wall socket when it is subjected to mechanical actions and stresses. The invention also seeks to make it easier to disconnect the device from the wall socket.

To this end, the invention proposes an electronic apparatus comprising a means of connection to a wall socket, at least one user interface means and at least one interface module between the user interface means and the connection means, wherein the apparatus comprises at least one elastic means in contact with the wall when the connection means is plugged into the wall socket, so as to stabilize the electronic apparatus in a predetermined position relative to the wall and a means for disconnecting the connection means from the wall socket, the at least one elastic means cooperating with the disconnecting means to facilitate the disconnection of the electronic apparatus.

Thus the electronic apparatus which undergoes mechanical stresses especially through its own weight or by the actions performed on its user interface means will remain in a stable position relative to the wall despite these stresses and actions. The connection means and the wall socket are therefore not damaged and the electronic apparatus cannot be inopportunely disconnected from its wall socket. The unclamping is facilitated by the action of elastic means which tend to move the electronic apparatus away from the wall as soon as it is unclamped.

The connection to the wall socket is especially reliable as the connection means comprises a means for clamping the electronic apparatus into the wall socket.

Thus, to be able to unclamp the apparatus from its wall socket, the electronic apparatus has a means for unclamping the connection means from the wall socket.

In particular embodiments, the elastic means is a piece of rubber placed on a surface of the apparatus facing the wall, or it comprises a helical spring.

Preferably, there are four elastic means.

In a preferred embodiment of the electronic apparatus according to the invention, the interface module is an electronic board.

This electronic board has an interconnection module adapted to transferring data from the user interface to the connection means.

In a preferred embodiment, the user interface means comprise one or more pushbuttons or one or more switches.

Thus, action on these pushbuttons or switches gives rise to mechanical forces on the electronic apparatus, which nevertheless remains stable owing to the elastic means provided for in the invention.

Similarly, when the user interface means consist of one or more connection means, the connection or disconnection of the cables or apparatuses to or from these connectors gives rise to mechanical stresses on the electronic apparatus. The elastic means according to the invention are then used to stabilize the apparatus in a stable position relative to the wall despite these forces.

When the electronic apparatus comprises a fan, the elastic means then serves as a vibration-damping means damping the motions of the apparatus caused by the fan.

Preferably, the means of connection to the wall socket is an RJ 45 type of male connector.

This electronic apparatus can advantageously serve as a connection device in a communications network to connect different communications apparatuses.

The invention also proposes an electronic device, comprising:
a connecting member operable to connect the device to a socket;
a main electric member fixed to the connecting member, the main electric member including an electric module for electrically connecting the module to the socket; and
an elastic member to be in contact with a wall for stabilizing the device relative to the wall;
said elastic member urges the device against the wall so as to help the connecting member disconnected.

### BRIEF DESCRIPTION OF THE DRAWINGS

Yet other specific features and advantages of the invention will appear from the following description.

In the appended figures, given by way of non-restrictive examples:

FIG. 1 shows a front view of the electronic apparatus according to the invention;

FIG. 2 shows a side view, along A, of the electronic apparatus according to a first embodiment of the invention;

FIG. 3 shows a side view along BB, of the electronic apparatus according to a particular embodiment of the invention and an additional part to be inserted into the apparatus;

FIG. 4 shows the rear face of the electronic apparatus according to the invention and an additional part to be inserted into the apparatus;

FIG. 5 shows a view identical to the one illustrated in FIG. 3 but with an additional part inserted into the apparatus;

FIG. 6 shows a side view, along A, of the electronic apparatus according to a particular embodiment of the invention;

FIG. 7 shows the electronic apparatus connected to a wall socket, according to the second embodiment of the invention;

FIG. 8 shows an enlargement of the elastic means of the electronic apparatus according to the second embodiment of the invention; and

FIG. 9 shows a home communications network in which it is planned to have the electronic apparatus according to the invention.

### MORE DETAILED DESCRIPTION

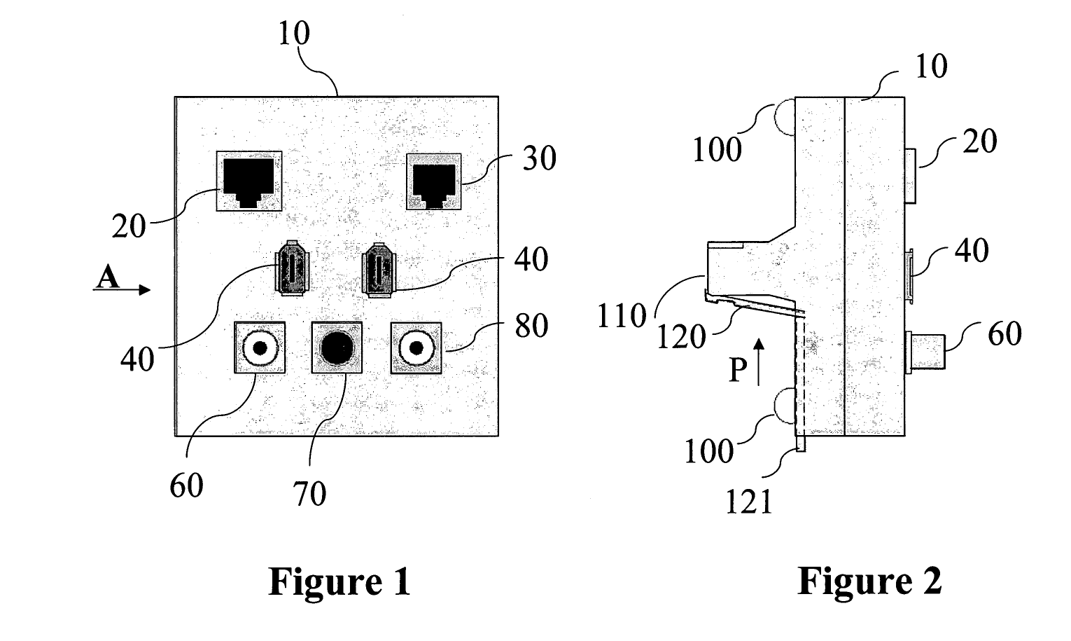

Referring to FIG. 1 we shall first describe an example of an electronic apparatus 10 according to a preferred embodiment of the invention.

This electronic apparatus comprises a plurality of connectors adapted to the receiving of matching connectors, for example RJ45 type connectors referenced 20 for the connection of data carrier cables, RJ11 type connectors referenced 30 for telephone connections, 1394 type connectors (of the IEEE 1394 standard) referenced 40 for the connections of apparatuses compliant with this standard and audio/video type connectors referenced 60, 70, 80, for the connections of apparatuses or audio/video cables. Thus, the electronic apparatus is capable of receiving several types of connectors. To this end, it has an electronic board 50 inside its casing. This board shall be described further below.

The weight of electronic board inside the casing is therefore not negligible relative to the weight of the casing, so that it can put the electronic apparatus out of balance when it is plugged into its wall socket.

Similarly, the connection or disconnection of the cables or apparatuses to or from the connectors of the electronic apparatus causes mechanical stresses to act on the electronic apparatus, thus possibly putting it out of balance or even damaging the connector plugged into the wall socket.

The front face of such a device may also have other interfaces such as push-button, programming command or switch type interfaces, not shown here, which could be used, for example, to program the electronic apparatus to work in different modes, enter a name or number of apparatus for example or again to put the apparatus into operation or stop it. In this case, action on the interfaces causes mechanical stresses that may destabilize the electronic apparatus or damage the wall socket.

FIG. 2, which is a side view along A of the electronic apparatus, shows elastic means 100 positioned on the rear face of the electronic apparatus in such a way that these means come into contact with the wall when the electronic apparatus is plugged into the wall socket.

In a first embodiment, these elastic means are rubber pins screwed into the rear face of the electronic apparatus or bonded to this rear face.

These pins, in contact with the wall, will enable the device to be stabilized in its position parallel to the wall so as to work optimally even under the effect of mechanical stresses such as those caused by the plugging in of a connector, the weight of the electronic board contained in the device and the vibration of the device if it has vibrating components such as, for example, a fan.

The electronic apparatus has a connector 110 shown in FIG. 2. This is a connector of the RJ45 or Ethernet type for example, that enables plugging into wall sockets of a same type. Indeed, RJ45 type wall sockets are generally laid out in rooms of dwellings and are designed for the installation of a home network. They are generally not suited to receiving heavy electronic apparatuses such as the one described.

Thus, the stabilization means 100 are useful for keeping the apparatus in a position parallel to the wall in the present example.

The wall connector 110 has a clip type clamping means not shown in the figure but well known to those skilled in the art for such a connector, used to clamp it into the wall socket. To unclamp the connector 110 from its wall socket, an unclamping means in the form of a flexible arm 120 is actuated in the direction of the arrow P shown in FIG. 2. The effort, in the direction represented by the arrow P, of the flexible arm 120 when the connector is clamped into the wall socket releases this connector from the wall socket.

According to the invention, this flexible arm 120 is extended by an additional arm 121 that goes beyond the casing in such way that the user can access it when the device is plugged into its wall socket.

Thus, when it is desired to unclamp the connector from its wall socket, it is enough to push the end of the additional arm 121 in the direction represented by the arrow P. This additional arm, in turn, will push the lever 120 which will unclamp the connector.

In a preferred mode, the additional arm 121 is an extension of the lever 120 and is one and the same part.

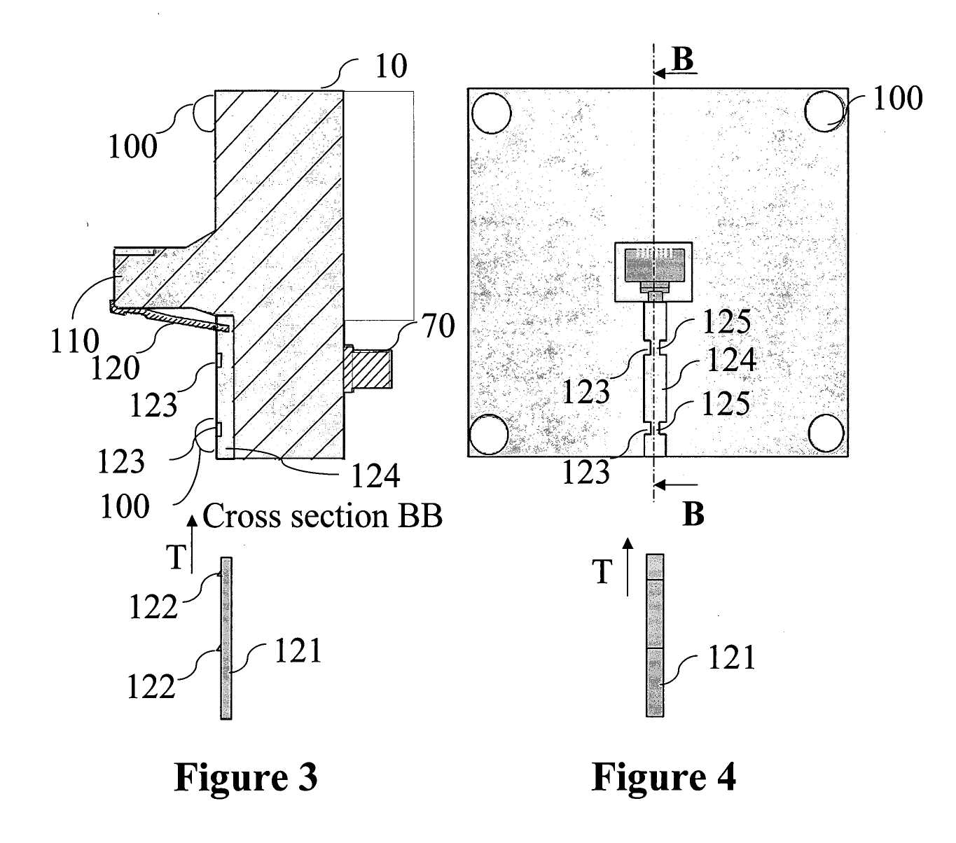

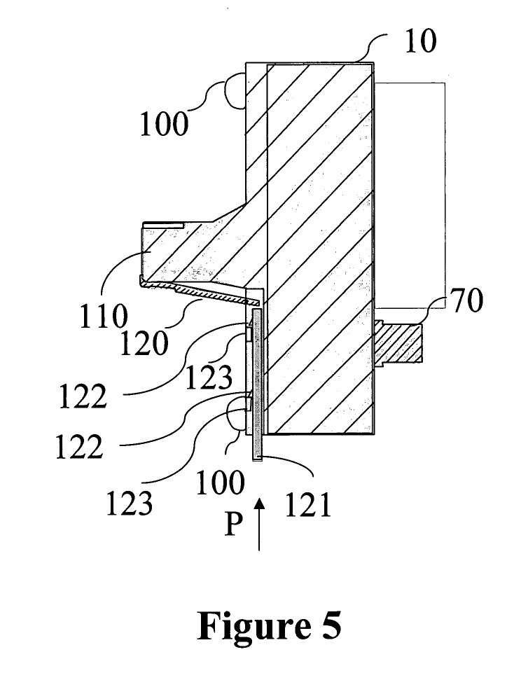

In another embodiment, this additional arm is independent of the flexible arm 120. This embodiment is shown in FIGS. 3 and 4 when the part 121 is outside the electronic apparatus and in FIG. 5 when the part 121 is inserted into the electronic apparatus.

Thus, as shown in FIG. 3, the device 10 has a recess 124 in which there are designed walls 123 serving as blocking stops for the part 121 when it is inserted. For this purpose, the part 121 possesses two protruding features 122 that come into contact with the walls 123 as illustrated in FIG. 5. To enable the insertion of the part 121 into the device, the walls 123 do not cover the entire width of the recess as illustrated in FIG. 4 where it is possible to see the separations 125 of the walls 123 on the width of the recess 124. Thus, the walls 123 offer sufficient flexibility for the insertion of an additional arm into the apparatus. This arm 121 gets inserted into the apparatus in the direction of the arrow T shown in FIGS. 3 and 4. Once the arm is inserted as shown in FIG. 5, the protruding portions 122 come into contact with the walls 123 so as to keep the arm in the device when it is in operating position. To be able to unclamp the connector 110, it is then enough to push the additional arm 121 in the direction of the arrow P shown in FIG. 5. This arm, in turn, then pushes the flexible arm 120 to unclamp the clamping system.

The elastic means 100 will also make it possible, during the actuation of the arm 121, to facilitate the disconnection of the electronic apparatus by the thrust force acting against the wall, as soon as the clip has been unclamped from the connector. The user will know more easily if the unclamping has effectively taken place because the device will be automatically moved away from the wall through the action of these elastic pins.

These elastic means are four in number in the example described, and are located at the four corners of the electronic apparatus.

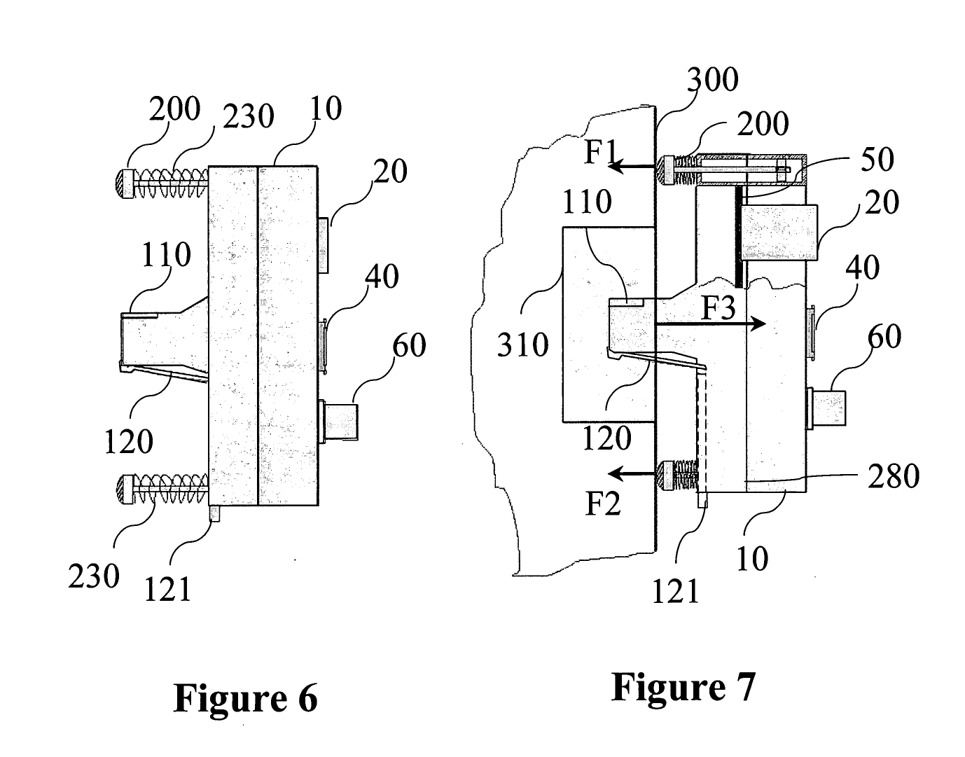

FIG. 6 shows a side view of a second embodiment of an electronic apparatus according to the invention. This device has elastic stabilizing means 200.

These means are equipped with helical springs 230 which are shown in FIG. 6 in the idle position.

During the connection of the connector 110 to the corresponding wall socket 310, the elastic means 200 are in a retracted position as can be seen in FIG. 7.

These elastic means then rest on the wall 300 so as to hold the device in a stable position. It can therefore be seen that the force exerted by the elastic means on the wall is equal in its totality (F1+F2) to the pull-out force F3 of the connector 110 in the wall socket 310 exerted by the clamping clip.

The vector F1 represents the combined force of the two upper springs and the vector F2 represents the combined force of the two lower springs. By way of a non-restrictive example, the force of a spring, in the case of the device described, is equal to IN.

Thus, the device is held in position in the plane parallel to the wall. This stabilization system prevents damage to the wall socket by preventing it from being subjected to strains on the axes forming a plane parallel to the wall. The RJ45 type wall sockets that are commonly available in the market have indeed not been designed to take strains of this type.

The electronic apparatus as shown comprises an electronic card 50. This electronic card comprises audio/video type connectors 60, 70, 80, connectors of the 1394 type (according to the IEEE1394 standard) referenced 40, Ethernet type connectors 20 and telephone type connectors 30 for example.

This electronic card also has components not shown in the figure, among them an interconnection module in charge of managing data transmission on the network.

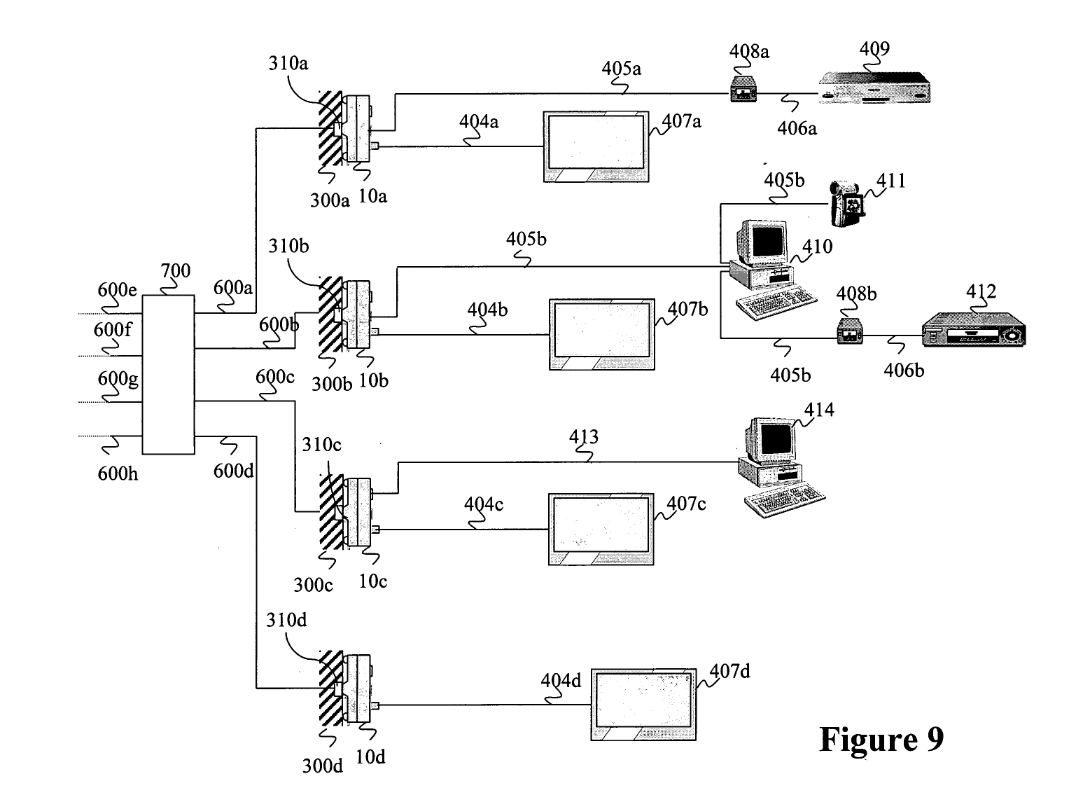

In a manner known to those skilled in the art, this module enables the conversion of the signals coming from the connections made on the front face into signals that will be conveyed in the home network by means of cables connecting the wall sockets of the dwelling. The home network will be described in greater detail in FIG. 9.

This interconnection module determines the source of the data stream according to the connection of the front face and constructs a header indicating the destination of the data packets. This interconnection module is responsible for multiplexing the data coming from the different connections and transmitting them to the data carrier cable of the network through the connector of the wall socket 110.

Conversely, the interconnection module, which receives data packets from the data carrier cable, coming from the home network, by means of a central device for example, will demultiplex this data in order to direct it to the output ports or the corresponding connection means 20, 30, 40, 60, 70 or 80. This module may also comprise a digital/analog converter responsible for converting the digital data into analog data intended, for example, to be displayed on an analog television set plugged into the audio/video connectors 60, 70, 80.

Thus, the electronic apparatus must carry out many functions such as multiplexing, demultiplexing and digital/analog conversion. Its electronic board therefore comprises many elements and its own weight could destabilize the electronic apparatus if it had no elastic means 100 or 200.

This electronic board 50 has a standard position in the casing of the electronic apparatus making it possible to have connectors on the front face and one connector on a rear face that is plugged into the wall socket. It thus serves as an interface module between the user interface means and the means of connection to the wall socket. In this case, the connection means is an Ethernet RJ45 type connector but it could be another type of connector. The conversion of the signals would then match the type of connection chosen.

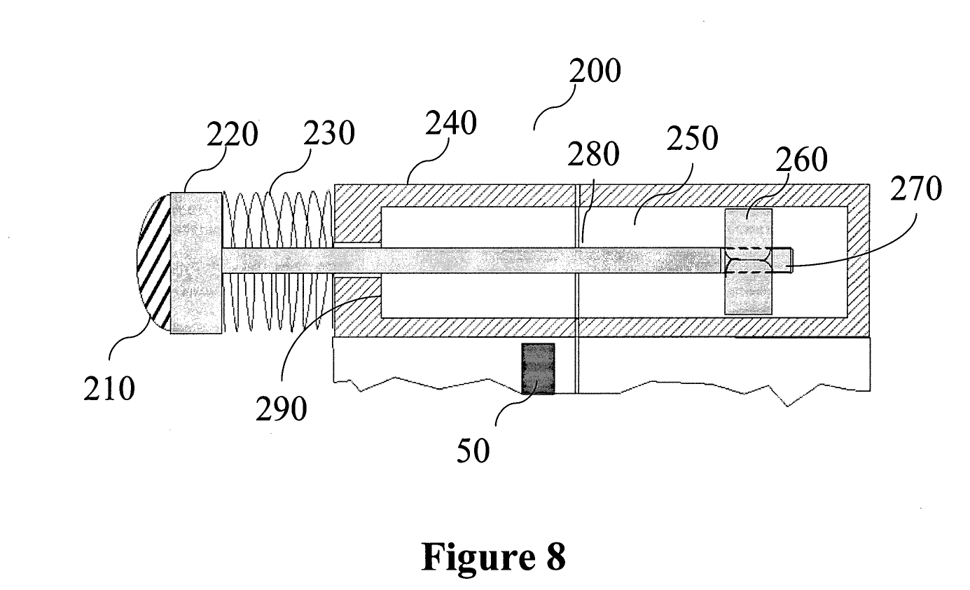

FIG. 8 is an enlarged view of an elastic means according to the second embodiment of the invention. This elastic means comprises a piston 220 associated with a pin 270, partly threaded at its end. The elastic means furthermore comprises a hollow body 250. This elastic means is separated by the line of demarcation 280 of the casing also shown in FIG. 7. The apparatus 10 is indeed constituted by two molded elements, the line of demarcation 280 representing the line where these two elements are fixed to each other.

A nut 260 is mounted on the threaded rod 270. This nut will be used to slide the shaft of the piston in the hollow body. When the elastic means is in the idle position, i.e. when the electronic apparatus is not connected to the wall socket, the nut will abut the internal face 290 of the hollow body so as to limit the motion of the piston.

The helical spring 230, in the retracted position in FIG. 7, applies the spring return force needed to keep the device in a stable position. It is also used during the disconnection of the connector 110, causing the electronic apparatus to move away from the wall as soon as the connector is unclamped.

FIG. 9 shows a home communications network in which the electronic apparatus according to the invention can be advantageously placed.

This multimedia communications network interconnects apparatuses such as television sets referenced 407a, 407b, 407c and 407d, a DVD type reader referenced 409, a videocassette recorder referenced 412, computer type apparatuses referenced 410 and 414, as well as a digital camcorder referenced 411.

The wall sockets 310a, 310b, 310c and 310d of the network shown in this figure are to be laid out in rooms of the dwelling and are, for example, Ethernet (RJ 45) type sockets. The network is installed so as to connect these wall sockets to a central system 700 by means of data carrier cables shown under the references 600a, 600b, 600c, 600d.

According to the invention, this network comprises electronic apparatuses referenced 10a, 10b, 10c and 10d that are plugged into the respective wall sockets 310a, 310b, 310c and 310d provided in the partition walls 300a, 300b, 300c and 300d of the rooms of the dwelling.

These electronic apparatuses are connected to a central device 700, preferably placed beside the electrical power supply panel, through cables referenced 600a, 600b, 600c and 600d. The central device is connected to other electronic apparatuses, not shown in the figure for the sake of simplicity, by cables 600e, 600f, 600g, 600h in such a way that it manages eight electronic apparatuses. This is of course an example of an embodiment of such a communications network.

The data carrier cables 600a to 600h are for example of the UTP5 (“Unshielded Twisted Pair, category 5”>> type as specified in the ANSI/TIA/EIA/568A standard) conventionally used in Ethernet type networks. It must be noted that other types of cables could be used, for example optical fibers or cables compliant with the IEEE1355 standard. In this case, the wall sockets 310a, 310b, 310c and 310d will be adapted to this type of cable.

The television set 407a is connected by means of an analog video link 404a to the electronic apparatus 10a. According to one variant, the link 404a may be compliant with the IEEE1394 standard and the television set then comprises an IEEE1394 board. Similarly, the television sets 407b, 407c and 407d are respectively connected to the connection devices 10b, 10c and 10d by means of analog video links 404b, 404c and 404d.

The DVD reader referenced 409 is connected by means of an analog link 406a to an analog-digital converter referenced 408a. This converter is itself converted by a digital link 405a compliant with the IEEE 1394 standard to the electronic apparatus 10a. This converter converts the analog video information generated by the DVD reader into a format compliant with the IEEE1394 standard.

The computer 410, the camcorder 411 and the analog-digital converter 408b are connected to one another and with the multimedia interface apparatus 10b by means of a digital link 405b compliant with the IEEE 1394 standard. The analog-digital converter 408b is itself connected to the analog videocassette recorder 412 by means of the link 406b.

The computer referenced 414 is connected by means of an Ethernet type link referenced 413 to the electronic apparatus 10c.

Each of the electronic apparatuses comprises at least connection means of the Ethernet and IEEE1394 types and an analog video output. All the information obtained by these electronic apparatuses is distributed to other remote electronic apparatuses through the central switching unit 700 and cables connecting this unit to the different electronic apparatuses. The central switching unit has a management module responsible for routing the digital type data packets in the communications network, as a function of the path information that they contain. This module enables centralized data management in the communications network.

The electronic apparatuses according to the invention are indeed particularly adapted to this type of network since they may comprise several connectors without in any way being out of balance and without damaging the connector of their wall socket. The wall socket therefore does not need to be sophisticated or particularly adapted to heavy electronic apparatuses. A classic network wall socket such as an Ethernet socket is therefore enough since the electronic apparatus possesses its own means of stabilization. The fact that this apparatus is directly plugged into the wall socket reduces the space requirement in the rooms of the dwelling and gives the network greater flexibility since, if it is desired to add connectors, it is enough to change the electronic apparatus instead of changing the wall sockets themselves.

Naturally, the present invention is in no way limited to the embodiments described and shown. On the contrary, it covers every variant within the scope of those skilled in the art.

1. An electronic apparatus comprising means of connection to a wall socket, at least one user interface means and at least one interface module between the user interface means and the connection means, wherein the apparatus comprises at least one elastic means in contact with the wall when the connection means is plugged into the wall socket, so as to stabilize the electronic apparatus in a predetermined position relative to the wall and means for disconnecting the connection means from the wall socket, the at least one elastic means cooperating with the disconnecting means to facilitate the disconnection of the electronic apparatus.

2. An electronic apparatus according to claim 1, wherein the connection means comprises means for clamping the electronic apparatus in the wall socket.

3. An electronic apparatus according to claim 2, wherein the means for disconnecting comprises means for unclamping the connection means from the wall socket.

4. An electronic apparatus according to claim 1, wherein the elastic means is a piece of rubber placed on a surface of the apparatus facing the wall.

5. An electronic apparatus according to claim 1, wherein the elastic means comprises a helical spring.

6. An electronic apparatus according to claim 1, comprising four elastic means.

7. An electronic apparatus according to claim 1, wherein the interface module is an electronic board.

8. An electronic apparatus according to claim 7, wherein the electronic board comprises an interconnection module adapted to transferring data from the user interface to the connection means.

9. An electronic apparatus according to claim 1, wherein the at least one user interface means is/are a pushbutton or pushbuttons or a switch or switches.

10. An electronic apparatus according to claim 1, wherein the at least one user interface means is a connection means.

11. An electronic apparatus according to claim 10, wherein the connection means is of the IEEE1394, Ethernet or audio/video type.

12. An electronic apparatus according to claim 1, comprising a fan.

13. An electronic apparatus according to claim 12, wherein the elastic means constitutes a vibration-damping means.

14. An electronic apparatus according to claim 1, wherein the means of connection to the wall socket is an RJ 45 type of male connector.

15. A communications network comprising at least one electronic apparatus according to one of the claims 1 to 14, to connect different communications apparatuses.

16. An electronic device, comprising:
a connecting member operable to connect the device to a socket;
a main electric member fixed to the connecting member, the main electric member including an electric module for electrically connecting the module to the socket; and
an elastic member to be in contact with a wall for stabilizing the device relative to the wall;
wherein said elastic member urges the device against the wall so as to help the connecting member disconnected.
